(19) United States
(12) Patent Application Publication
(10) Pub. No.: US 2025/0284671 A1
(43) Pub. Date: Sep. 11, 2025

(54) METHOD AND APPARATUS FOR THE INTELLIGENT CAPTURE AND PREPROCESSING OF UNSTRUCTURED CONTENT FOR UPSTREAM OR DOWNSTREAM WORKFLOW INTEGRATION

(71) Applicant: Weave Cloud Solutions, LLC., Ocala, FL (US)

(72) Inventors: Robert N. CICHIELO, Asbury, NJ (US); Paul J. BANCO, Colts Neck, NJ (US); Emil STURNIOLO, Medina, OH (US); Benjamin David MANNING, Malvern, PA (US)

(21) Appl. No.: 19/075,603

(22) Filed: Mar. 10, 2025

Related U.S. Application Data
(60) Provisional application No. 63/563,155, filed on Mar. 8, 2024.

(51) Int. Cl. G06F 16/215; G06F 16/34; G06F 40/58

(52) U.S. Cl. CPC G06F 16/215; G06F 16/345; G06F 40/58

(57) ABSTRACT

This technology relates to field of Intelligent Document Processing (IDP) and more particularly to the methods, apparatus, and systems that enables the capture and handling of unstructured content; enabling the pre-processing of such captured content to extract, classify, convert, and/or summarize the captured content; providing at least one of the extracted content, the original captured content, and/or any generated ancillary information about the captured content (metadata); potentially allowing the efficient triage of such content, extracted content, and/or metadata by automated or manual processes; and determining whether to forward at least one of such captured content, extracted information, and/or metadata to upstream or downstream workflow processes or request corrections or additions to such content from the source of the provided content.

### CROSS-REFERENCES TO RELATED APPLICATIONS

This application claims the benefit of U.S. Provisional Patent Application No. 63/563,155 filed Mar. 8, 2024, which is incorporated herein by reference in its entirety and for all purposes.

### STATEMENT REGARDING FEDERALLY SPONSORED RESEARCH OR DEVELOPMENT

### FIELD

This technology relates to field of Intelligent Document Processing (IDP) and more particularly to the methods, apparatus, and systems that enables the capture and handling of unstructured content; enabling the pre-processing of such captured content to extract, classify, convert, and/or summarize the captured content; providing at least one of the extracted content, the original captured content, and/or any generated ancillary information about the captured content (metadata); potentially allowing the efficient triage of such content, extracted content, and/or metadata by automated or manual processes; and determining whether to forward at least one of such captured content, extracted information, and/or metadata to upstream or downstream workflow processes or request corrections or additions to such content from the source of the provided content.

### BACKGROUND & SUMMARY

Ever since Fredrick Bakewell's patented invention in 1848¹, captured content has been able to be communicated over long distances. Many improvements to this capability have been made over the intervening years, allowing such information to be exchanged at greater speeds and precision, however the construct of the communicated information remains the same. Information is generated by an originator of the exchange and received by the at least one recipient. Unless there is an “a priori” arrangement between the participants of an exchange, the type of information being communicated is “unstructured”, and it is left up to each recipient to determine the type of content that has been received. For instance, anyone who has ever used a facsimile machine knows that received information may be content that a recipient is expecting, or totally unsolicited information such as advertisements for roofing or a menu from a local restaurant. ¹ https://www.nypl.org/sites/default/files/Bakwell-12353.pdf

While there have been many advances over the years, efficient content management is still a significant issue for public and private sector organizations. For thousands of years, information has been and is still being recorded on paper. Since the early 1800s, images have been captured or reproduced on photosensitive substrate (a.k.a. film, thermal transfer paper, etc.) also colloquially called “hard copy”. Even though today a majority of information is now digitally represented (i.e. captured directly by computational resources), either humans persist in generating hard copies of this electronically stored/captured information, or the upstream or downstream computational resources are not programmed to accept/understand the information from the originating system, thus causing the information to be output on paper. Quite often these hard copies are then “re-digitized” by utilizing electronic scanning solutions as an “image/picture”, losing contextual metadata about the information that was associated with the original electronic representation. The re-digitized versions of the content then may be forward to other computational resources for further upstream or downstream workflow processing in a less than a desirable format.

This problem has given rise to an entire class of solutions known to those schooled in the art as Intelligent Document Processing systems (IDP) to assist in the processing of unstructured content. While IDP solutions have come to the forefront recently with the use of Artificial Intelligence (AI), intelligently capturing and processing documents is not a new phenomenon. In 1914, Emanuel Goldberg developed a machine that read characters and converted them into standard telegraph code². However, it wasn't until 1978, when Kurzweil Computer Products Company (Ray Kurzweil³) began selling a commercial version of his optical character recognition (OCR) computer program. LexisNexis⁴ was one of the first commercial customers of the Kurzweil machine and bought the system to upload legal paper and news documents onto its nascent online databases. Other uses of this OCR system were also developed in the late 1970's and early 1980's by companies such as the Compugraphics Corporation⁵ for the newspaper and printing industries to capture and convert hardcopy text/manuscripts into electronic copies. Other attempts were made by organizations in the mid 1980's to intelligently handle the creation and updates to electronically generated documents, for instance by the Datability Corporation⁶ with their then commercially available FACSYS application. ³ Ray Kurzwel—Wikipedia⁴ LexisNexis—Wikipedia⁵ Computergraphic—Wikipedia⁶ DATABILITY, INC. in New York, NY|Company Info & Reviews

In one illustrative environment, healthcare providers handle vast amounts of content on a daily basis, much of which is “scanned in” and still communicated in an unstructured format via traditional facsimile capable systems, email applications or file transfer services. Upon reception of the copies of the re-digitized content by the recipient healthcare organization, this received content often needs to be manually entered/transcribed into electronic medical records (EMRs), electronic health records (EHRs), and/or Referral Management systems. Large healthcare organizations employ an entire department of employees whose sole job is to review each and every incoming document (content) received, check for errors, and either transcribe the received content into the receiving organization's computational resource-a process that is both time-consuming and significantly prone to errors; or return the information to the originator to resolve any problems that may have occurred during the re-digitization or communication processes.

This issue is not solely limited to healthcare, but occurs across a wide spectrum of vertical industries, including but not limited to financial, insurance, law enforcement, and many other governmental agencies. Consider the recent trend in mobile banking as another illustrative example. No longer are bank customers required to visit brick and mortar branch location or an automated teller machine (ATM) to deposit a physical/paper check received for payment. Customers can now “take a picture” of the hard copy check with their mobile device's camera and forward the electronically digitized version of the check to their financial institution. Upon reception, some process (either manual or automated) is required at the financial institution to triage the received information to ensure that the information captured is sufficient for it to: a) establish a financial transaction with the corresponding financial institution; and b) complete the transfer of funds from the originator's account to the recipient's account.

If one considers the number of checks a financial institution receives or documents a healthcare organization may receive in one day, the reader can easily appreciate that processing unstructured content is quite an involved, time-consuming, error-prone, and a somewhat mundane endeavor for the individuals' task with this effort. In fact, maintaining competent personnel to staff this specific task becomes an intractable problem for many organizations, increasing the probability of errors occurring during any transcribing necessary.

The exemplary illustrative non-limiting technologies described herein can help automate these processes, by digitally capturing information from incoming unstructured content, processing the captured information through natural language processing techniques, to (re) create structured content and context relative metadata that can be used to help triage the content as well as convert the information into an arrangement that can be used to pass such information into upstream or downstream processes with little to no manual intervention. Such integration with the upstream or downstream processes can be achieved in multiple ways including, but not limited to, Application Programing Interfaces (API), logical connectors, forked files or segmented payloads with ancillary information that includes at least two of: the original content, any extracted content, and/or metadata, etc.

A method comprising:
receiving an unstructured data set;
transforming the unstructured data set into a data arrangement configured to be consumed by an upstream or downstream computational process, the transforming including extracting data from the unstructured data set;
testing the data arrangement to determine whether confidence in the data arrangement is below a threshold;
conditionally presenting the data arrangement for exception processing based on whether the testing reveals confidence in the data arrangement is below the threshold, the exception processing performing further analysis on the unstructured data set and/or the data arrangement; and
using a machine learning component to automatically generate a summary of the data arrangement;

The method described above wherein the data arrangement and the summary is presented on a user interface.

The method described above wherein the exception processing comprises human interaction for a predefined metric, a requirement, and/or learned rules.

The method described above wherein the exception processing includes analyzing handwritten information.

The method described above wherein the exception processing includes translating from one natural language to another natural language.

The method described above wherein the testing tests for missing data, grammatical errors, typographical errors, and classification errors.

The method described above wherein the testing tests whether the received unstructured data set is invalid altogether.

The method described above further including improving reliability of the data arrangement by minimizing potential for human error during a tedious, repetitive, and mundane transcription process.

The method described above wherein receiving comprises receiving information in many formats from many different inputs, and transforming comprises extracting and transforming the data set into content that can be consumed by another system or process.

### BRIEF DESCRIPTION OF THE DRAWINGS

FIG. 1 is a block diagram of an exemplary non-limiting system architecture.

FIG. 2 is a block diagram of the computational environment of an illustrative non-limiting embodiment of the system

FIG. 3 is an exemplary illustrative embodiment of unstructured and structured content.

FIGS. 4 through 25b show an exemplary illustrative embodiment user interface features to assist in the processing of the received content, the extracted information, and/or contextual metadata.

FIG. 26 is an exemplary illustrative embodiment showing that the at least one received content, extracted data, or contextual metadata has been successfully received and processed by an upstream or downstream process.

### DETAILED DESCRIPTION OF EXAMPLE NON-LIMITING EMBODIMENTS

The exemplary illustrative embodiments provided herein describe an adjunct Intelligent Document Processing (IDP) solution that ingests, classifies, and extract information from received content. Upon reception of the content, the system automates workflows procedures surrounding the received contents journey, as well as enabling the triage of such content prior to forwarding the at least one of the received content, the extracted information, and/or contextual metadata in a suitable arrangement necessary for upstream or downstream processes that are utilized to continue the progression of the workflow method.

As illustrative examples of upstream or downstream processes, the IDP solution may interface with at least one of:
Electronic Medical Records solutions (EMRs)
Electronic Health Records solutions (EHRs)
Electronic Referral Management solutions (ERMs)
Financial Records solutions (FRs)
Criminal Records solutions (CRs)
Insurance Records solutions (IRs)
Etc.
   to integrate the at least one of the received content, the extracted information, and/or the contextual metadata directly into the upstream or downstream process(es) (also known as Business Process Management tools (BPMS)), minimizing or totally eliminating the need for manual data entry. Thus, the at least one illustrative embodiment of the aforementioned IDP solution (Weave Flow™) described herein provides an intelligent automation solution that can be considered a “digital workforce of virtual employees” that can enhance, augment, and/or eliminate certain human interactions in a workflow process.

Functional features of the exemplary embodiment include, but are not limited to:
1. Content Intake: accept/receive content from at least one of various originating sources, including, but not limited to email, messaging applications, collaboration tools, web forms, capture devices, web hooks, remote procedure calls, application programing interfaces, file systems, cloud service offerings, etc. The content may also be presented in commonly known structured and unstructured formats including, but not limited to PDF, Word, Excel, TIF, etc.
2. Content Classification: classify received content based on the received information content and any contextual metadata associated with the received content. To minimize manual interaction in the workflow process, Flow may utilize machine learning algorithms that can identify patterns within the received structured or unstructured content and contextual metadata.
3. Content Extraction: extract information from the classified content. To further minimize manual interaction, Flow may utilize machine optical character recognition (OCR) techniques and natural language processing (NLP) algorithms.
4. Content Workflow Automation: automate the processing of the extracted information. This can be achieved by interfacing with upstream or downstream systems or Business Process Management (BPM) tools that can further define and execute workflows.
5. Reduce Errors and increase efficiency: By augmenting and/or mitigating the manual steps in preparing content for ingestion by the at least one aforementioned upstream or downstream processes, reduces the potential for human error in the process, making the overall solution more reliable, and efficient.

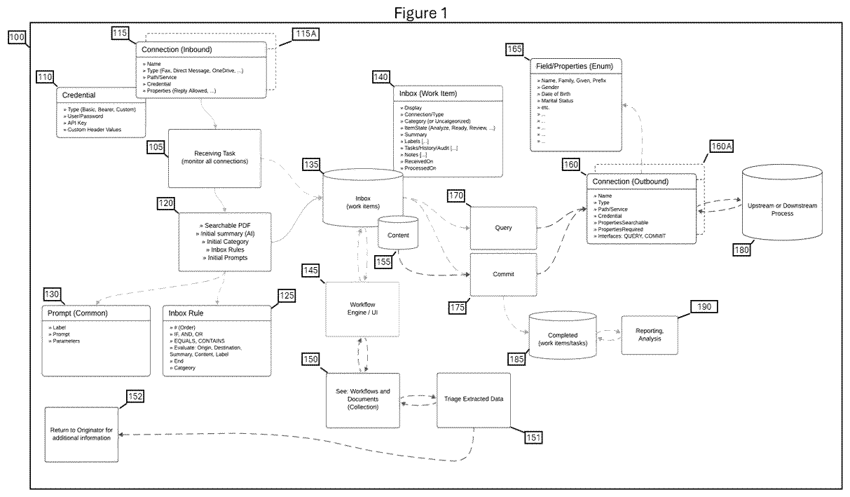

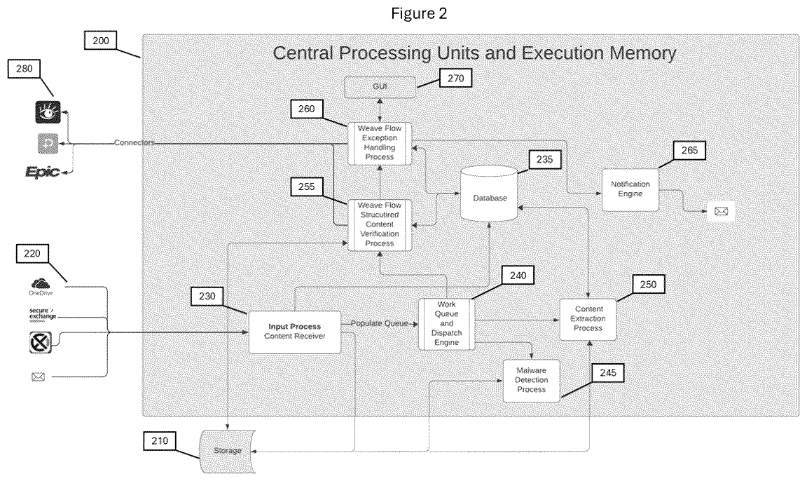

Referring to FIG. 1, system (100) provides a high-level overview of the at least one illustrative embodiments of the Weave Flow IDP solution. Beginning at the receiving/intake task (105), system (100) is configured to receive and or ingest content potentially from a variety of originating resources. Receiving task (105) monitors for the at least one inbound path (115, 115A, etc.). To ensure that the at least one inbound path(s) (115/115A) only exchanges content with authenticated originating peer resources (not shown), task (105) may be a priori configured with credentials (110) to enable the at least one originating peer resources to securely authenticate to system (100). This step helps ensure the privacy and security of the exchanged content, as well as providing non-repudiation of the originating resource, thus allowing the aforementioned upstream and/or downstream process(es) (180) to trust the chain of custody of the content being processed by the IDP system (100).

Upon completion of the secure reception of the content, the receiving task (105) conducts an initial assessment of the content received at step (120). In one non-limiting illustrative embodiment, the incoming content is converted into a searchable PDF format, potentially via a machine executable OCR process. The output of the OCR process is then passed to an Artificial Intelligence (AI) process that utilizes natural language processing algorithms to help classify and/or generate a summary of the received content. The AI process is guided by a basic set of known inbound rules (125), also known as templates, that are tailored to extract required or override information necessary for passing the at least one of the original content, the extracted information, and/or contextual metadata, to the intended upstream or downstream process(es) (180). The IDP can also be configured with specific prompts (130) that are unique to a particular deployment of the upstream or downstream process(es) (180) to further augment the workflow procedure. Upon completion of the receive task (105), the at least one original received content, the extracted information, and/or any contextual metadata is then place into the inbox work item queue (135).

Upon detection by workflow engine (145) of a work item being held in Inbox (135) que, workflow engine begins to interrogate the at least one original received content, the extracted information, and/or any contextual metadata to ensure that it meets the necessary criteria to pass such information to the intended upstream or downstream process(es) (180). This step acts as a way point along the content route to enable triage of the previously received and processed information passed in by the receiving task (105). As depicted in step (140) the exemplary workflow engine (145) validates that the necessary information is present.

However, in some cases, the content and/or contextual metadata is not classified, summarized, and/or extracted correctly by receive task (105). This might be caused by missing or garbled information present in the source content itself. Or it could be caused by the aforementioned AI process included in step (120), which may return a less than acceptable confidence level regarding its ability to process the supplied content. In any case, at this point manual intervention may be necessary. In one non-limiting illustrative embodiment, the IDP solution provides a user interface (150) to enable a user of the system to review the store Inbox information and potentially correct any defects that may be apparent. In one trivial illustrative example, the received content may have contained date information in the wrong format, as the upstream or downstream process (180) is expecting dates to be in the standardized and accepted United States representation of month/day/year, however the information in the original content may have been provided in the more international representation of day/month/year. This simple error can derail an upstream/downstream process (180), for instance the searching for a patient's medical record by name and birthdate. Thus, the non-limiting illustrative embodiment allows a human operator to triage the information at step (151) present within an inbox (135) work item, potentially on an exception basis, to aid in the submission of the information to the at least one upstream or downstream process(es) (180).

There are other conditions that may require further attention. In the one aforementioned trivial illustrative example mentioned above, instead of the date being in the wrong format, the date-of-birth information may either be illegible or totally missing. In this case, the operator may need to reroute the received information back to the originating resource for further correction/amendment. Step (151) allows the operator to request such correction via step (152) via a return route, that return route may be either derived depending on the originating peer resource (for instance the from address in an email, or the originating phone number on a facsimile document), or preconfigured as part of the account/credential information supplied when the peer resource is being onboarded to the IDP system (100).

It is to be understood by those schooled in the art that the aforementioned illustrative example is non-limiting, as many other conditions may require intervention prior to forwarding the at least one of the received content, the extracted information, and/or the contextual metadata to the upstream or downstream process(es) (180). Therefore, it is a desirable feature of the described non-limiting exemplary embodiment is to either minimized or totally eliminate manual intervention in a majority of the cases of handling received content. However, the system is flexible enough to allow for exception handling of the information present within system (100), thus more effectively managing the information intake process by exception instead of by the rule, further increasing the overall efficiency of the upstream and/or downstream workflow process(es) (180).

Assuming that the information present such as content (155) and any extracted and contextual metadata (140), within an inbox (135) item is verifiably correct, Workflow engine (145) then begins the process of promoting the required information to the upstream and/or downstream process(es) (180). In one non-limiting illustrative embodiment, based on configured routing information, workflow engine (145) checks the associated connectors (160, 160A, etc.) to begin to map the at least one received content, extracted information, and/or the contextual metadata to the required fields as depicted in field properties (165). For instance, in one non-limiting illustrative example, the upstream or downstream process(es) (180) may expect a persons surname to be in the field named “Last Name”. However, the source information only provided a single “Name” field that contained both the given name and surname together. Through the extraction and possibly AI prompting, the provide name information was separated into “First Name” and “Last Name” objects. Using this extracted and/or contextual metadata, workflow engine (155) can then map the information into the correct field as identified in field properties (165) that is associated with each connector (160/160A).

Upon ensuring that all information required by connector (160/160A) is present, workflow engine (145) begins the process of passing the at least one of the received content, the extracted information, and/or the contextual metadata to the identified upstream and/or downstream process(es) (180). To minimize the interaction between the IDP solution, minimally only one endpoint is required to be accessible to the IDP of the upstream or downstream process(es) (180). In one non-limiting illustrative embodiment, if the at least one upstream or downstream process(es) (180) only requires creating new records, the workflow engine will interact with the at least one upstream or downstream process(es) (180) to commit the at least one received content, extracted information, or contextual metadata at step (175) to the at least one upstream or downstream process(es) (180).

Alternatively, in another non-limiting illustrative embodiment, if the at least one upstream or downstream process(es) (180) allows for the amendment of an existing record and permits a query operation to occur, workflow engine (145) will first query the at least one upstream or downstream process(es) (180) to gain access to the at least one previously established record(s). Upon successful retrieval of the at least one record identifier(s), workflow engine (145) will interact with the at least one upstream or downstream process(es) (180) to commit the at least one received content, extracted information, and/or contextual metadata at step (175) to the record(s) identified via the previous query operation(s) via the at least one upstream or downstream process(es) (180). If no record identifiers were found, then the workflow engine may either create a new record as described previously or generate an error to either alert the operator that further manual intervention may be required via triage step (151), and/or potentially alert (if possible) the originating peer resource (not shown) that the received information could not be further processed.

Assuming successful completion of the commit step (175), the work item is moved from the inbox (135) to the completed work item queue (185). Depending on the security, privacy, and/or sensitivity considerations surrounding the received content, in certain non-limiting illustrative embodiment, at least one of the received content, the extracted information, and/or contextual metadata may be purged from the system. At minimum however, transactional information about the processing by the IDP solution will be retained for reporting and analysis purposes at step (190). In other alternative non-limiting illustrative embodiment, the received content, the extracted information, and/or contextual metadata may be retained for business resiliency purposes.

For the sake of brevity and clarity, the steps are listed serially and/or in synchronous order. However, many of the steps outlined can be completed asynchronously to allow more efficient processing. Furthermore, the precedence order of checking the status of the tasks (105, 145, 150, 170, 175, etc.) may be implementation specific. In a more advanced or different environment, each operation may happen in parallel, and the order of checking the status may happen asynchronously to one another.

Referring to FIG. 2. FIG. 2 is a representative illustrative embodiment of the computational environment necessary for the Weave Flow system to operate. FIG. 2 environment (200) illustrates a standard computing execution environment comprised of at least one central processing unit with attached execution memory, such as static and/or dynamic random-access volatile memory (RAM), non-volatile memory such as read only memory (ROM), that allows for the execution of the at least one or more processes (230, 235, 240, 245, 250, 255, 260, 265, 270).

In FIG. 2's illustrative embodiment, system 200 may also be coupled to an electronic storage medium (210) such as solid-state storage, network storage, or other storage medium appropriate for the execution environment, that may be utilized for the storage (transient or otherwise) of the received content, the extracted information, and/or contextual metadata.

FIG. 2 components 220 and 280 are external computational resources that are operated and/or managed by third parties or subscribers of the Weave Flow Services.

It is to be understood that the originating and/or upstream and downstream computational resources may take many forms including but not limited to enhanced facsimile capable systems, capture devices such as scanners, collaborative applications such as Microsoft Teams or Slack, Email systems such as Microsoft Outlook or Google Gmail, purpose built applications such as electronic health or medical records, financial, insurance, industrial, criminal, pharmaceutical systems, file transfer and storage systems such as Microsoft SharePoint or AWS S3 storage, as well as any other upstream or downstream applications and resource that provide the ability to exchange content between systems.

It is to be understood that the aforementioned IDP solution may be implemented within hardware, firmware, as software component(s) or application(s), or provided as a cloud service offering, each of which utilizes computational resources configured to execute the described operations. Computational resources comprise of one or more computing systems, such as servers, each comprising one or more processors connected to non-volatile memory. The one or more processors execute software instructions stored in the non-volatile memory to perform operations.

Embodiments may be implemented in hardware, software, firmware, or combinations thereof.

Embodiments may also be deployed in multiple devices or in a single device.

Embodiments may be implemented in quantum computing environments.

Embodiments may also be deployed within Cloud Service Providers offerings, whether that be in virtual machine environments, or serverless computing environments.

It is to be understood that some, none, or all of the task enumerated within the non-limiting illustrative embodiments may be deployed within Cloud Service Providers offerings, whether that be in virtual machine environments, or serverless computing environments.

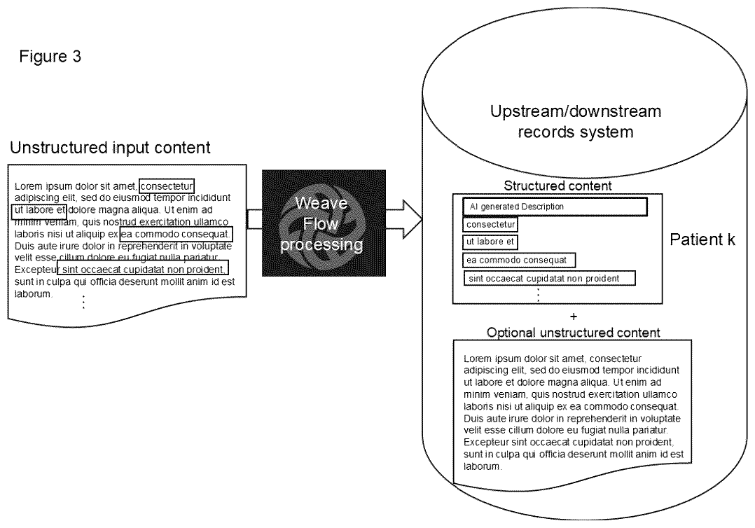

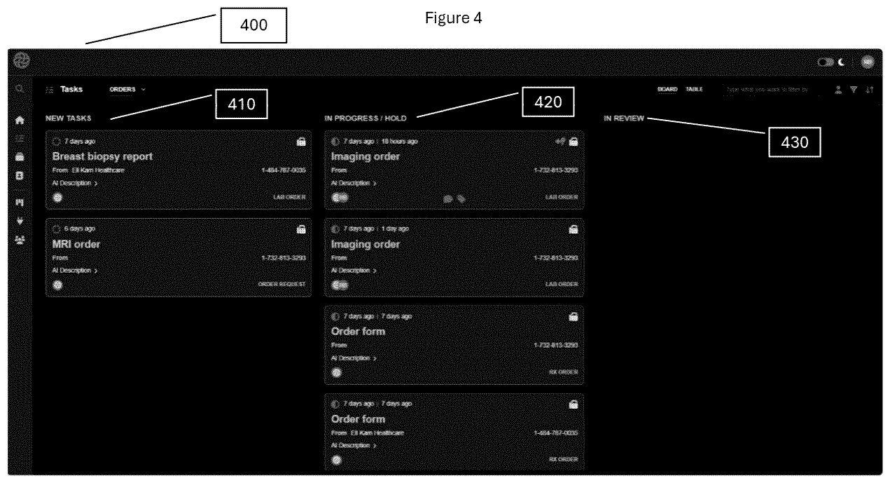

FIG. 3 provides an exemplary illustration of unstructured content being transformed via the tasks and/or processes represented in FIG. 1 and/or FIG. 2 into structured content. The structure content is then transferred to the third party upstream and/or downstream processes (180) and/or (280). Optionally, the original unstructured content may also be provided transferred to the third party upstream and/or downstream processes of FIG. 1 (180) and/or FIG. 2 (280) and recorded as the source of record for the at least one of the received content, the extracted information, and/or contextual metadata.

It is to be understood by those schooled in the art that while FIG. 3 references “Patient k” as a representative non-limiting example of a medical record system being the recipient of the structured content, the upstream/downstream process of FIG. 1 (180) and/or FIG. 2 (280) can be any system or service that can accept inbound content in an agreed upon arrangement.

Referring to FIG. 4, in the event that manual intervention is required or necessary to triage the at least one of the received content, the extracted information, and/or contextual metadata, a user may be presented with via FIG. 2 GUI (270). To those schooled in the art, a diagrammatic non-limiting illustrative embodiment of UI (400) is presented as a collection of kanban items of new content (410), in process and/or on-hold content (420), and/or in review content (430). Presented as “swim lanes”, this representation allows for the quick perusal of the at least one of the received content, the extracted information, contextual metadata, ancillary information, and/or indicia by the user. As information is received and processed by the underlying Weave Flow technology, in this non-limiting illustrative exemplary embodiment, information requiring manual intervention would populate within the new task swim lane (410). Upon actions by the user of the queued items in swim lane (410), the queued item could then be migrated from the new task swim lane (410) to the in progress/hold swim lane (420) if further attention is required. It is also possible that the presented information may be subject to additional review based on compliance parameters that include, but not limited to, organizational factors, regulatory, and/or statutory requirements. In such cases, processing of the information may be transferred to a collaborator and/or an automated verification process, thus be listed in the “in review” swim lane (430) waiting for further action and/or approval.

The reader will easily recognize that this exemplary embodiment has been geared towards healthcare organizations, however the example technology described herein has broad applicability across industries. It is important to note that all information represented within the non-limiting illustrative embodiment refers to fictious individuals; any resemblance to actual persons, living or dead or actual events is purely coincidental. Certain information has further been redacted, in the unlikely event it references an actual individual. In this non-limiting illustrative exemplary embodiment a wealth of information is presented in a clear and concise manner. For instance, the user can clearly see the classification of the new information being presented (410); A Breast Cancer Biopsy report; an MRI order; etc. Each item may also indicate how long the information is within the system, where/who the information was received from, the originator's network identifier (telephone number, email address, etc.), content type (lab order, order request, etc.), as well as a summary of the information that was extracted/generated by the artificial intelligence summarization and extraction processing (AI Description). Other indicia may also be presented by iconic symbols within each item.

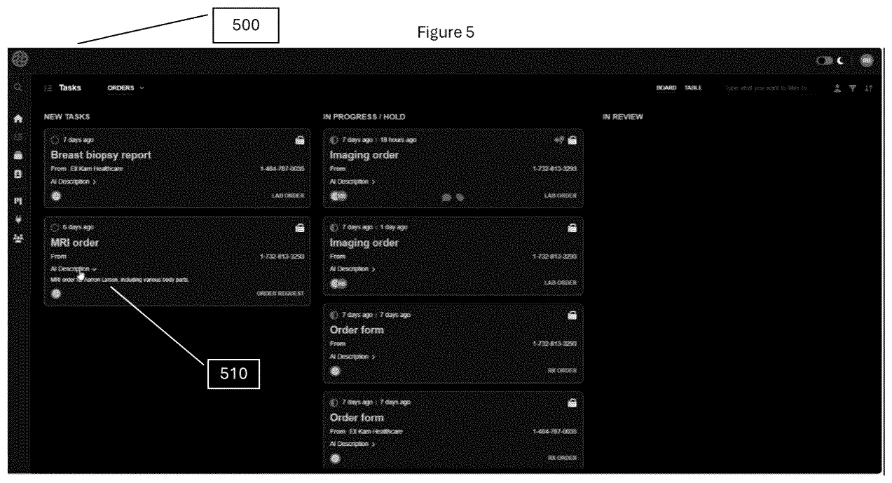

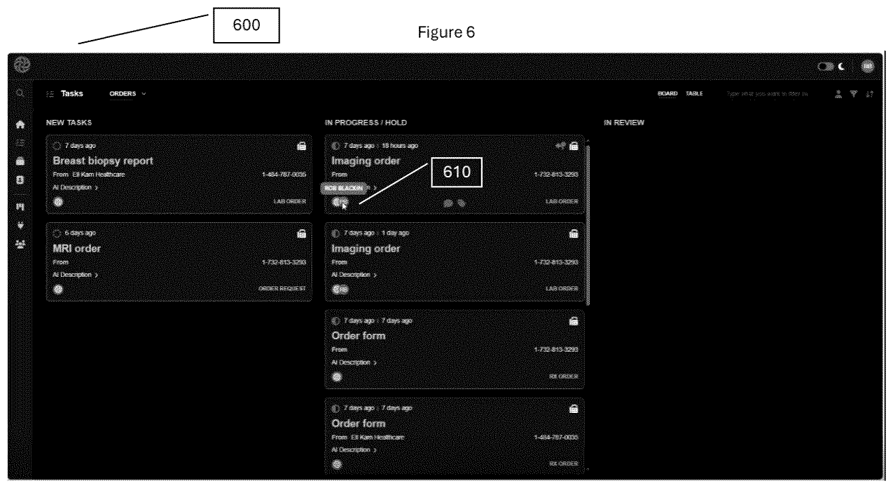

Referring to FIG. 5, in the non-limiting illustrative UI representation (500), a user may have selected to see more detailed information regarding the MRI order. In this non-limiting exemplary embodiment, the user selected to see item (510), the summarization of the MRI order showing that the order was for the fictitious “Aaron Larson including various body parts”. The user of the UI can now easily ascertain the context of the order without having to read through the minutia of the content, significantly decreasing the amount of effort involved in any manual processing that may be required.

Referring to FIG. 6, in the non-limiting illustrative UI representation (600), an operator of the system can now also quickly ascertain who, if any collaborators are associated with processing the information. In the exemplary embodiment, a user can quickly ascertain which colleagues have been involved in processing the information. The iconic representation, along with the help hints (610), identified the at least one workforce member and/or automated process that have been involved in handling the information through any manual or exception handling.

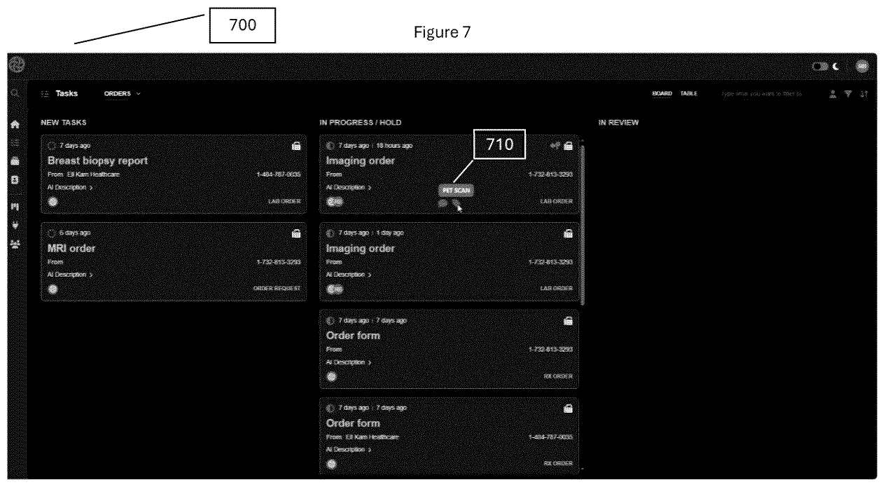

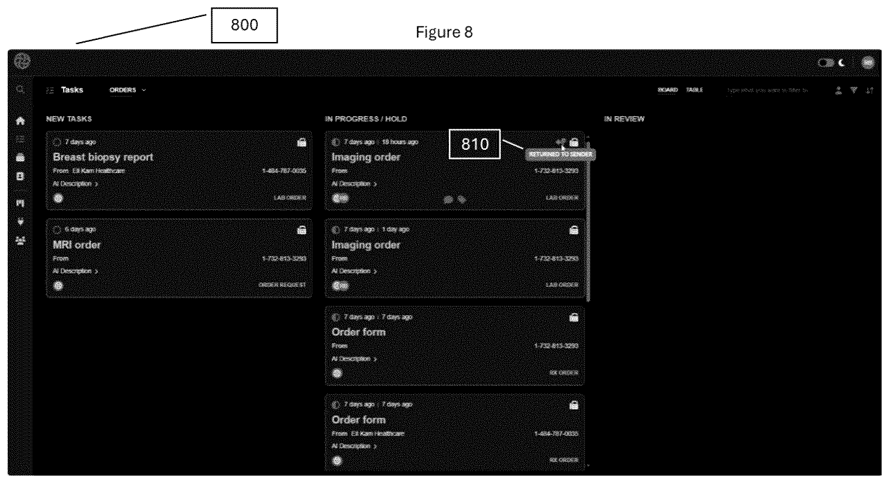

Referring to FIG. 7, in the non-limiting illustrative UI representation (700), the UI can also provide guidance as to what type of specific operation/function the information may be referring to. As indicated in the illustrative example item (710) shows that the imaging order is identifying a positron emission tomography (PET) scan is being ordered for a particular individual. Again, depending on the industry, this could easily represent other types of work requests. For instance, in the financial world, this might be a stock trade order, a mortgage loan application, or other financial transaction.

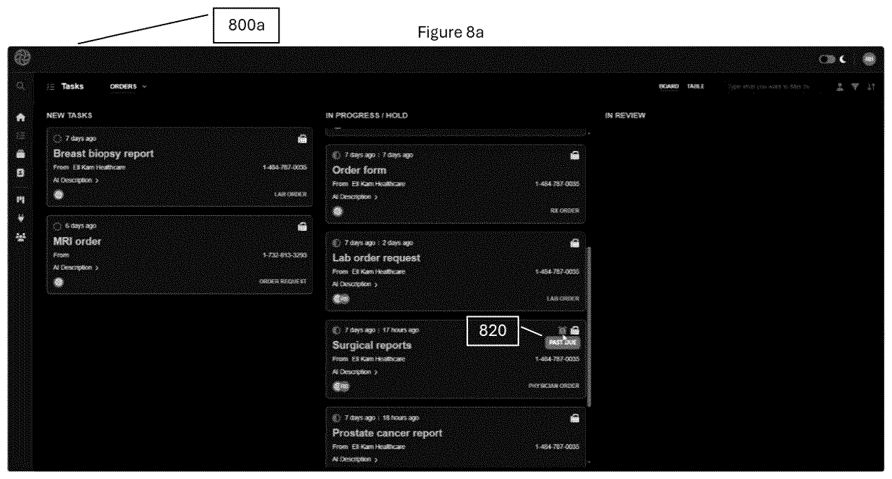

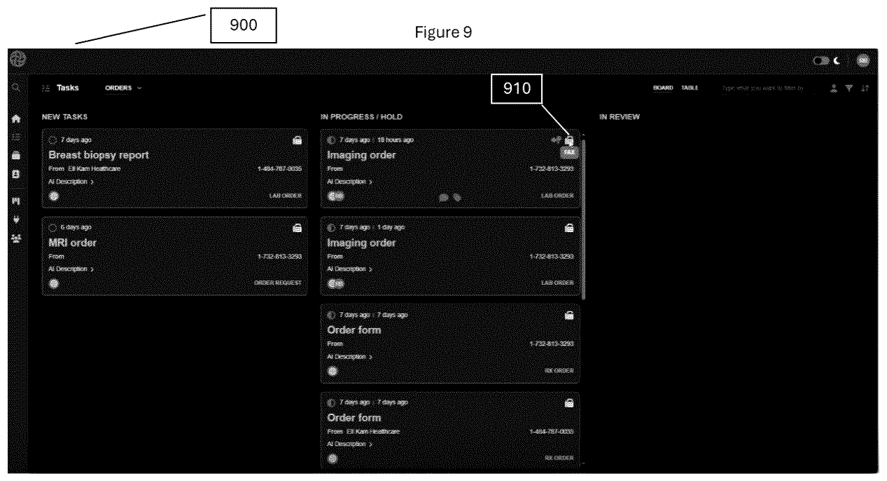

Referring to FIG. 8, in the non-limiting illustrative UI representation (800), the UI may allow for an operator to determine that there may be additional information required from, or correspondence needed with the originator. As indicated in the illustrative example, item (810) shows that the information is in progress, however the received content was returned to the sender and is in a wait state (hold).

Referring to FIG. 8a, the non-limiting illustrative UI representation (800a) similarly may allow for an operator to determine that the item is past due with respect to a predetermined timeline. As indicated in the illustrative example item (820) shows that the information is in progress but was expected to be delivered within a certain period of time. The timeline may be imposed by the organization, or in compliance with regulatory or statutory requirements. The non-limiting illustrative UI alerts an operator to the current state of the item that is in progress/on hold.

Referring to FIG. 9, the non-limiting illustrative UI representation (900), may inform an operator as to which input the original content was received. Item (910) shows that the imaging order was received via facsimile transmission. It should be easily understood by those schooled in the art that other communication methodologies, whether it be specific to a particular industry, or generically used across industries, may also be indicated, including but not limited to email, Direct Messaging, HL7, FHIR, file drop, and/or other messaging/document exchange protocol or methods.

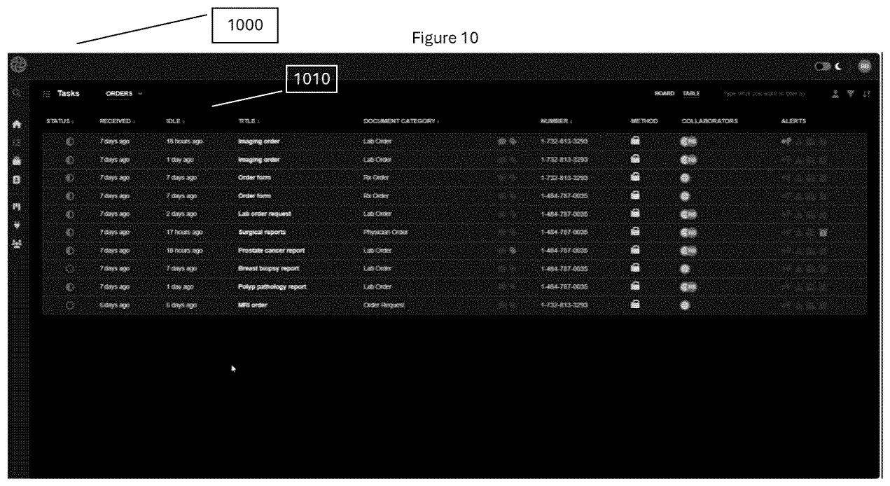

Referring to FIG. 10, the non-limiting illustrative UI representation (1000) may provide an alternative view from the kanban representation. Users of the UI may prefer to see the information presented in a list or table view over the kanban representation. As indicated in the illustrative example, item (1010) shows a similar representation of the information presented in previous diagrams. Item (1010) may also show additional information that may not be present within the kanban representation. For instance, item (1010) also shows an “idle time” column. This time references the last time a list members information was accessed versus the time when the information was received. This parameter may assist in helping users of the UI as well as their supervisors to prioritize the work queue.

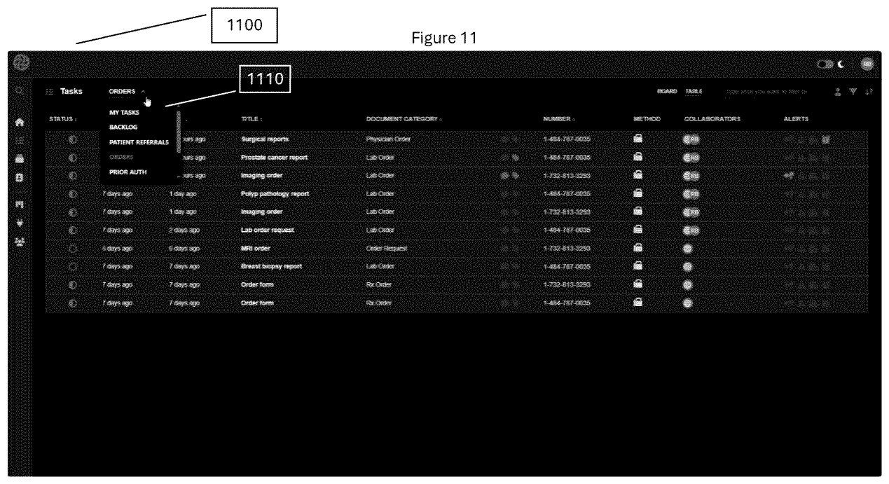

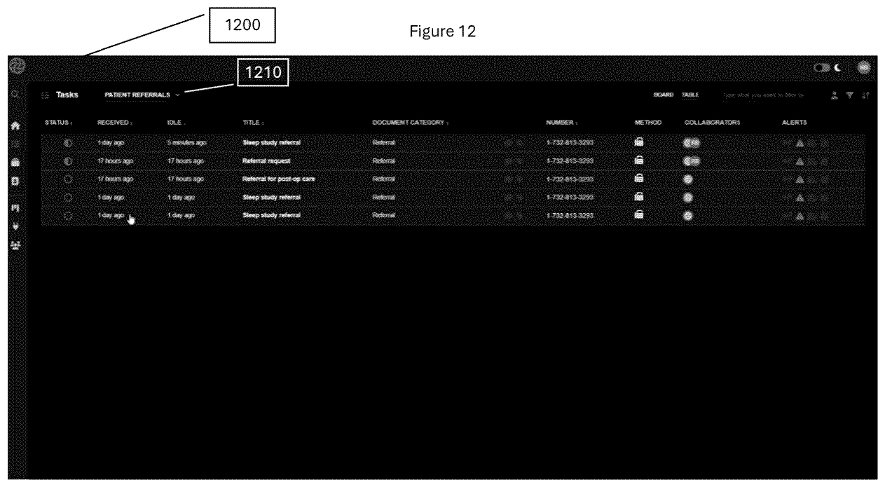

Referring to FIG. 11, the non-limiting illustrative UI representation (1100) may provide an alternative view from the kanban representation the “swim lanes”. All-encompassing list views may be difficult to navigate, even with filtering. Item (1110) represents a non-limiting example of how a user may switch between the different “swim lanes” or “boards” as they are colloquially called that are represented in the kanban view. The drop-down list as exemplified by item (1110) allows an operate to quickly select a particular list to review or operate on, without additional filtering or navigation of the UI. The lists themselves can be designed to be data driven, allowing for their dynamic creation, modification, or deletion.

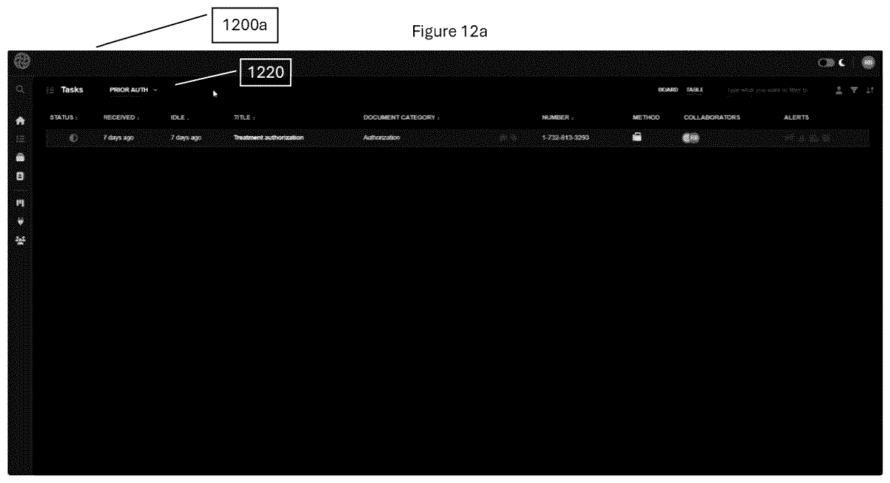

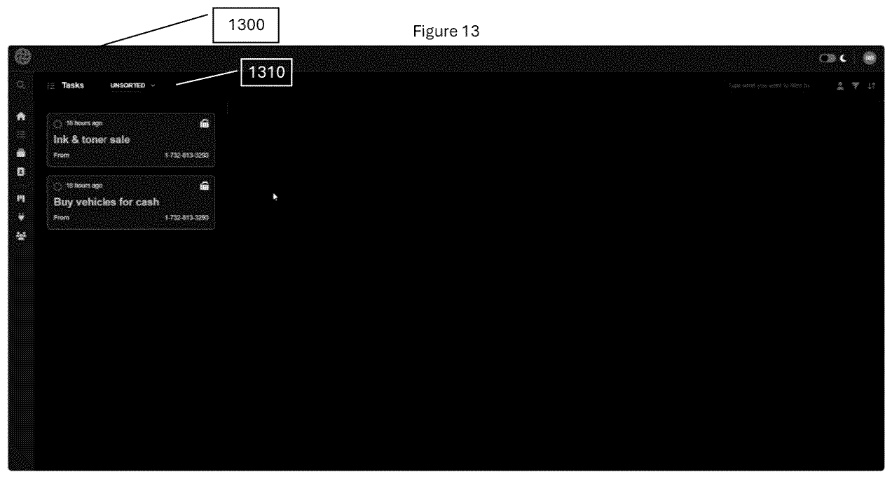

Referring to FIG. 12, the non-limiting illustrative UI representation (1200), item (1210) shows that a different list (the “patient referral” list) was selected by the operator.

Referring to FIG. 12a, the non-limiting illustrative UI representation (1200a), item (1220) shows another different list (the “prior authorization” list) was selected by the operator. Again, depending on the industry, the list could easily represent other types of pending or in progress work items.

In any exchange of information, the possibility of receiving invalid or corrupt information is highly likely. Therefore, in such systems as described herein, there must be a methodology for handling exceptions. In FIG. 13, in the non-limiting illustrative UI representation (1300), the UI allows an operator to review information received that does not meet the characteristics of the expected content to be received. As indicated previously, the non-limiting illustrative has been tailored to expect healthcare related information. If the exception handling within the system detects that a particular piece of information is not recognizable or in accordance with attributes of the expected content, the system may be configured to either reject the information out of hand or allowed in this case for manual intervention. An operator of the non-limiting illustrative UI may be presented with a list of unclassified, or indeterminate information that may not be relevant within the guise of the expected content. As such, the “unsorted” list (1310) may be presented to the operator for additional triage. For instance, the kanban items within UI representation (1300) indicate that the content received was an advertisement for printer ink and toner sales or an advertisement for purchasing vehicles. The Weave Flow technology may detect that its confidence is low regarding this errant information and queues the content for further investigation. Upon reviewing the content, an operator may best determine if the information should be expunged or triage it for further processing.

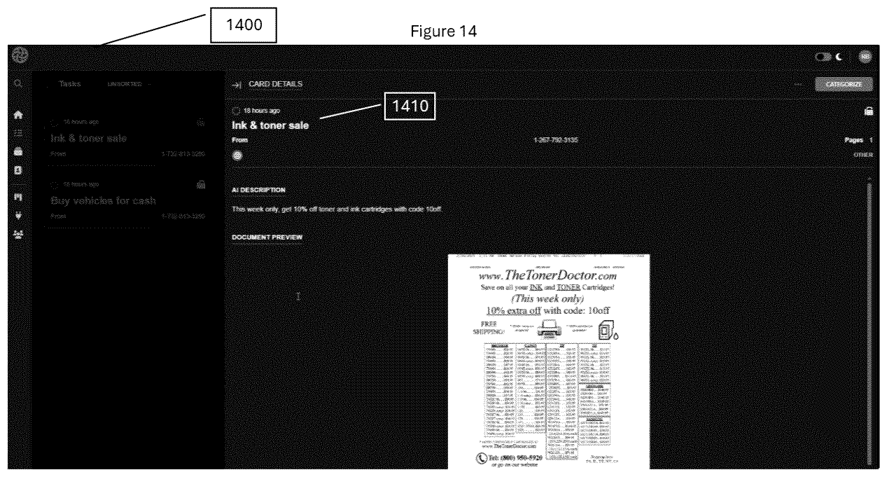

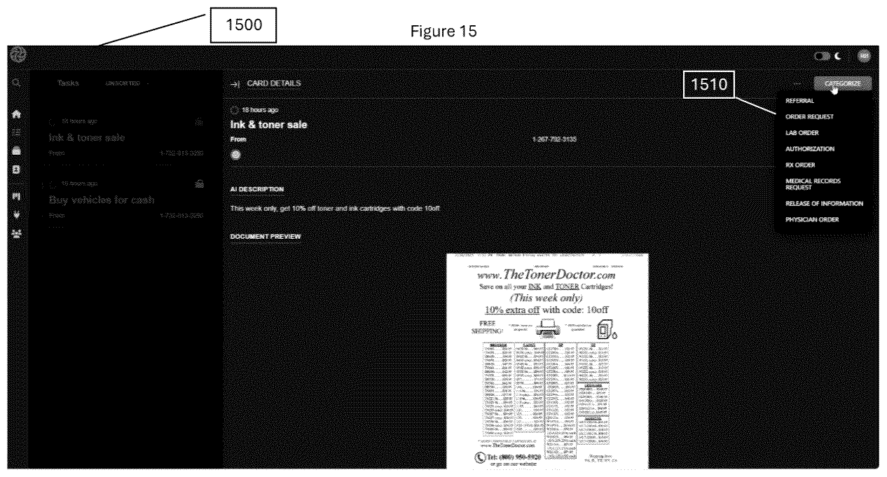

Referring to FIG. 14, the non-limiting illustrative UI representation (1400), item (1410) represents that an operator selected to execute additional triage on the at least one received content, the extracted information, contextual metadata. Item 1410 shows one of the unclassified (unsorted) items represented in FIG. 13, the Ink and toner advertisement. Using this display the operator can see the at least one received content, the extracted information, and/or contextual metadata, allowing the operator to make an efficient determination of whether or not the information presented is relevant to the task at hand.

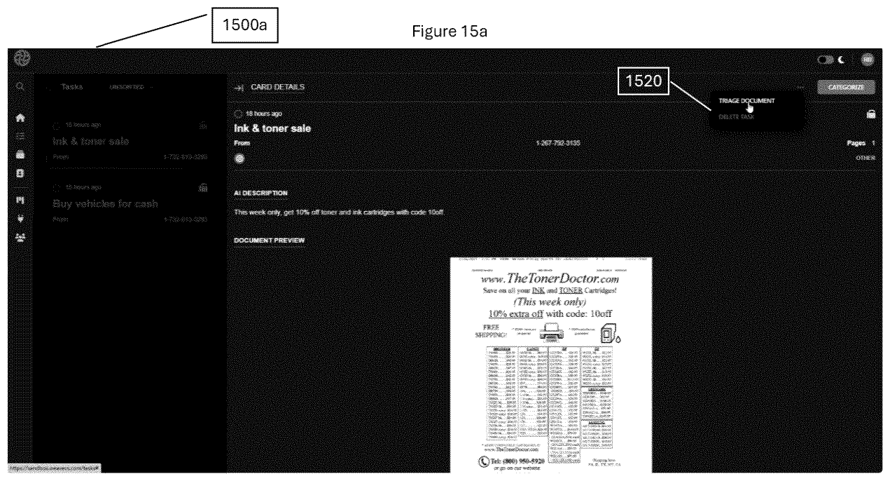

Similarly referring to FIG. 15, the non-limiting illustrative UI representation (1500) represents that the operator can easily override and select an option to re-categorize the at least one received content, the extracted information, and/or contextual metadata, by utilizing the drop-down menu presented by item (1510). Ignoring the fact that the information being shown in UI representation (1500) is an advertisement, the information presented could have easily been in such a format that the Weave Flow processing may have resulted with low confidence that the automated process could successfully discern the category of the information without manual intervention. As shown, UI representation (1500) allows an operator to intercede in the process when necessary, thus more efficiently handling exception cases.

Alternatively referring to FIG. 15a, instead of recategorizing the information, the non-limiting illustrative UI representation (1500a) represents that an operator can easily delete the task (1520) from the queue of items to be processed. In this case the received ink and toner advertisement would be removed from any further processing by the Weave Flow technology, thus protecting any upstream or downstream processes from irrelevant information.

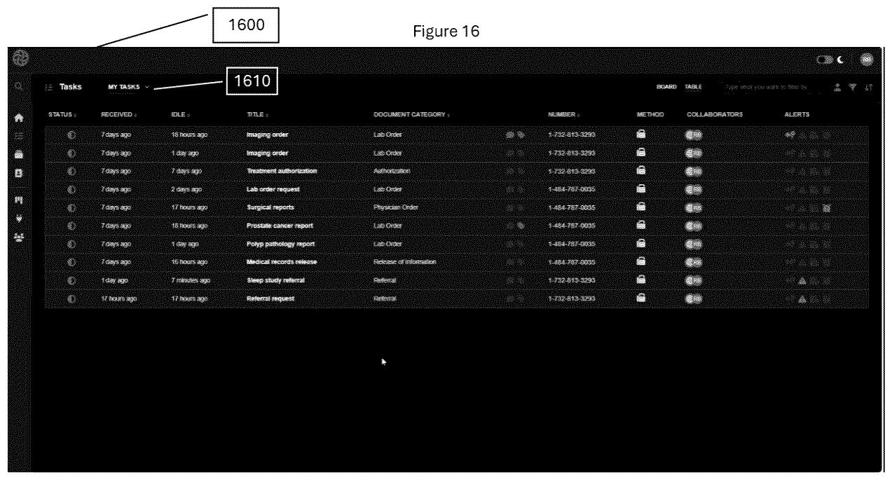

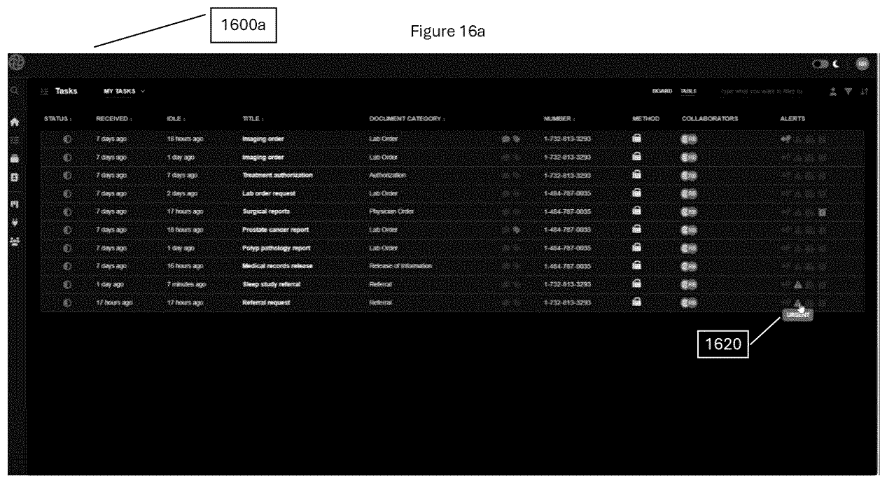

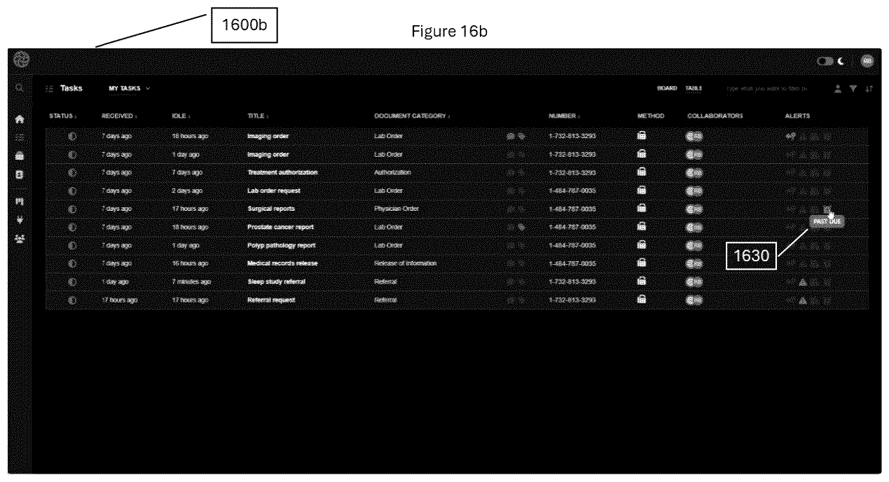

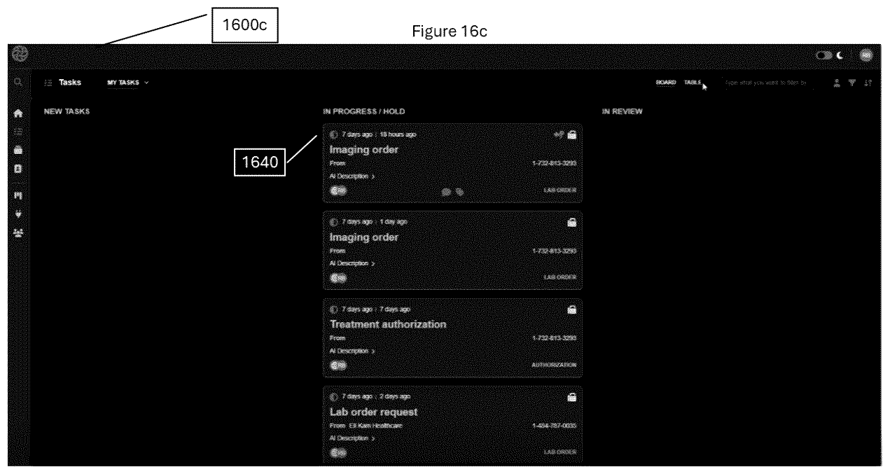

Referring to FIG. 16, the non-limiting illustrative UI representation (1600), item (1610) represents that an operator can manipulate a list view of tasks to only show those tasks that have been assigned and/or are pending for the operator to act upon without additional filtering or navigation of the UI. This is important to allow operators to more efficiently navigate any backlog especially when an organization may be handling hundreds, if not thousands of documents in a single day.

Similarly, referring to FIG. 16a, the non-limiting illustrative UI representation (1600a), item (1620) can further indicate to an operator that certain tasks in the presented list are more urgent than others, further assisting in the efficient processing of the at least one received content, the extracted information, and/or contextual metadata.

Alternatively, referring to FIG. 16b, the non-limiting illustrative UI representation (1600b), item (1630) can further indicate to an operator that certain tasks in the presented list are past due, further assisting in the timely processing of the at least one received content, the extracted information, and/or contextual metadata.

Referring to FIG. 16c, the non-limiting illustrative UI representation (1600c), item (1640) represents the ability of an operator to preferentially view the tasks assigned to then and/or are pending for the operator to act upon in kanban format, instead of the previously presented list view as shown in FIG. 16.

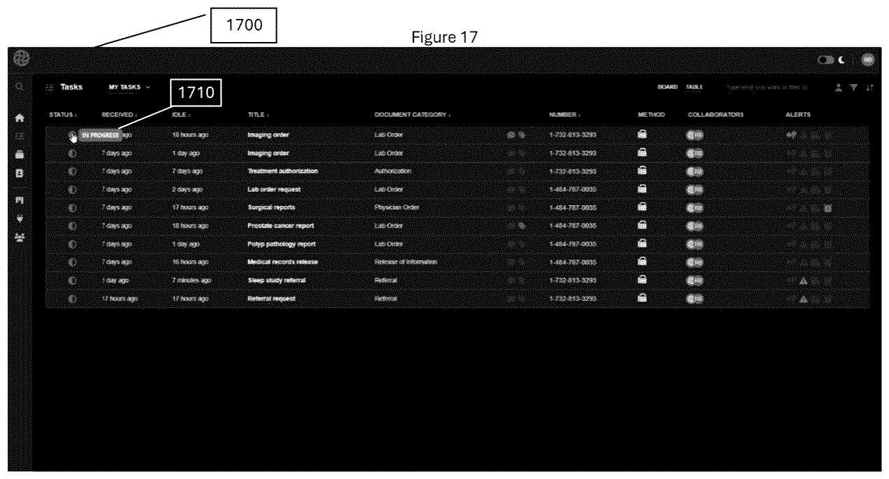

Referring to FIG. 17, the non-limiting illustrative UI representation (1700), item (1710) represents the ability of an operator to quickly ascertain the status of each item within the list of tasks assigned to then and/or are pending for the operator to act upon. The indicia can show whether each of the presented task items are in progress or work needs to be started on the task.

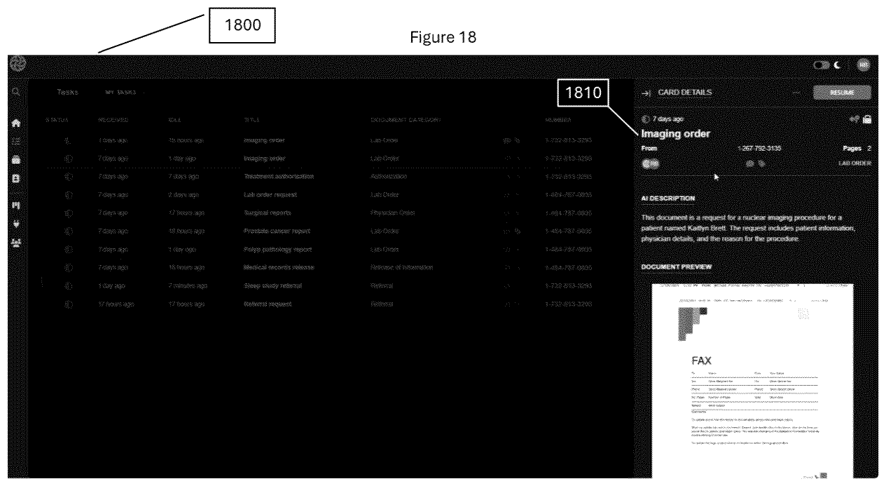

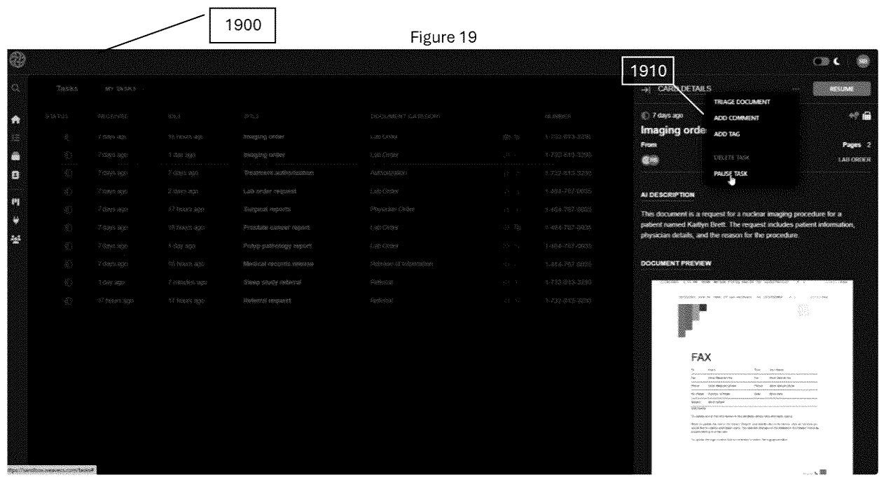

Referring to FIG. 18, the non-limiting illustrative UI representation (1800), item (1810) represents the ability of an operator quickly display a current synopsis of the at least one received content, the extracted information, and/or contextual metadata. This representation minimizes the need for an operator to fully navigate the UI to triage the information just to ascertain its current state and whether the information can progress to the next step in its processing by the Weave Flow technology.

Referring to FIG. 19, the non-limiting illustrative UI representation (1900), item (1910) represents the ability of an operator to be able to quickly: a) leave a comment regarding the information presented; b) add a tag that can capture ancillary information associated with the task; c) delete the task entirely; d) pause the task; and/or e) begin or resume the triage process of the at least one received content, the extracted information, and/or contextual metadata.

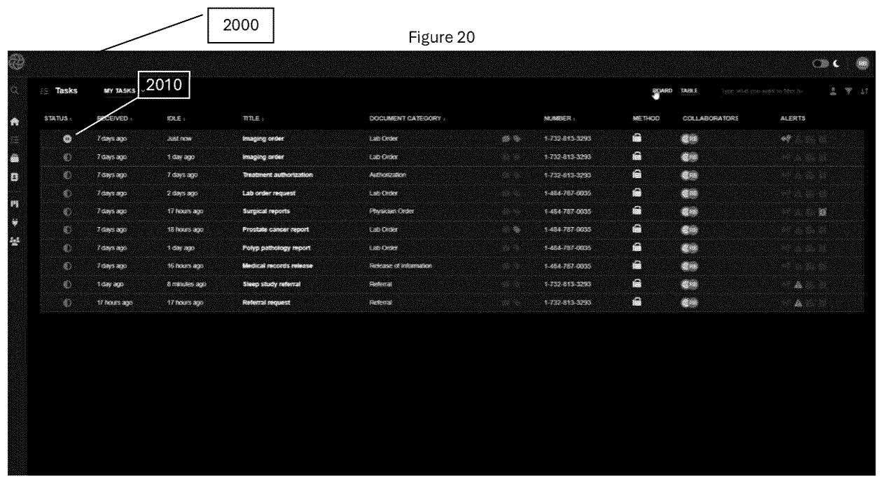

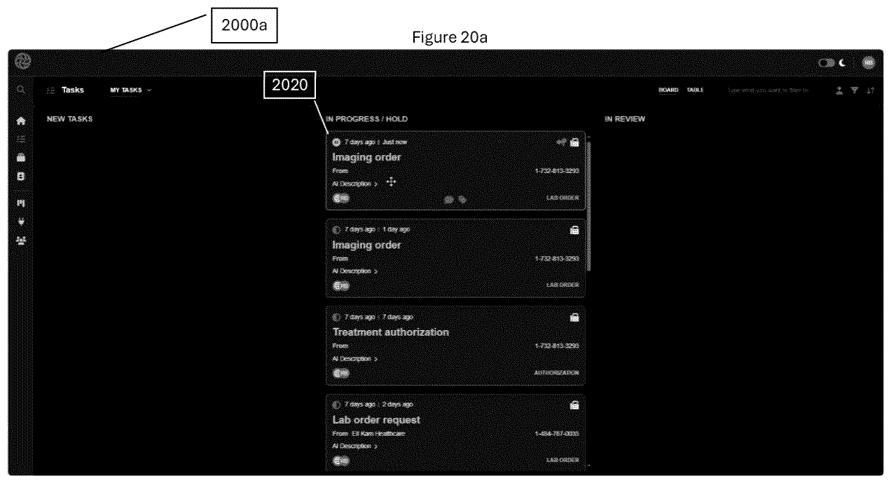

Referring to FIG. 20, the non-limiting illustrative UI representation (2000) shows that in the event that an operator has chosen to pause a specific task, item (2010), the indicia associated with status of a task, reflects the “paused” state in lieu of the “in progress” state as shown in FIG. 17.

Similarly, referring to FIG. 20a, the non-limiting illustrative UI representation (2000a) shows the kanban view of an operator's tasks. Item (2020) shows that not only is the indicia associated with status of a task, reflecting the “paused” state, but the outline of the kanban board item is modified to further draw an operator's attention regarding the state of the list element.

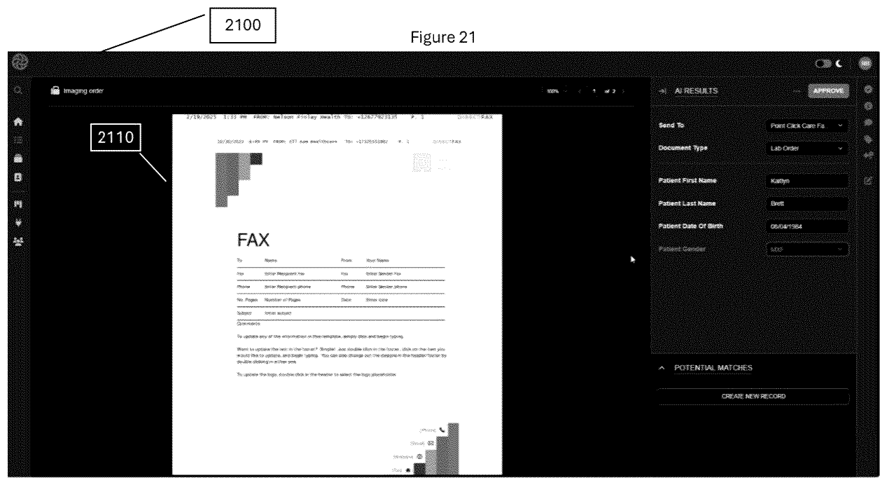

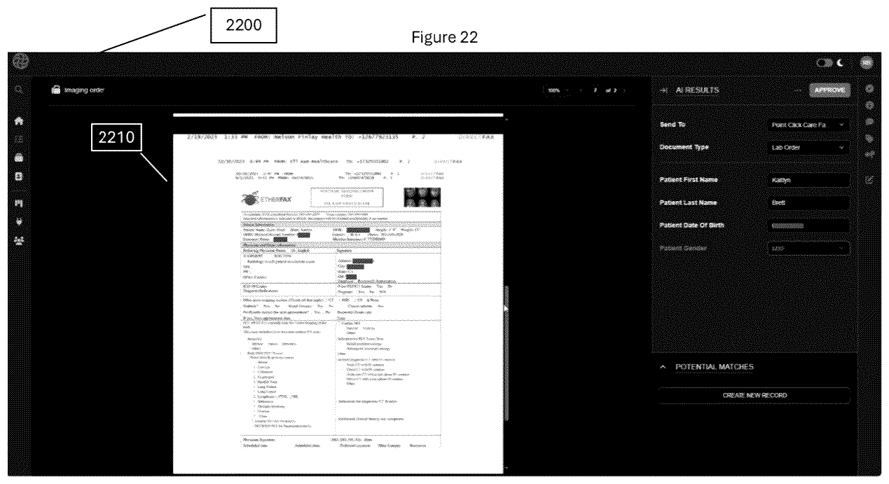

Referring to FIG. 21, in the non-limiting illustrative UI representation (2100) an operator has selected the option to triage the at least one received content, the extracted information, and/or contextual metadata. In this figure item (2110) is presenting the original first page of the received content for perusal by the operator.

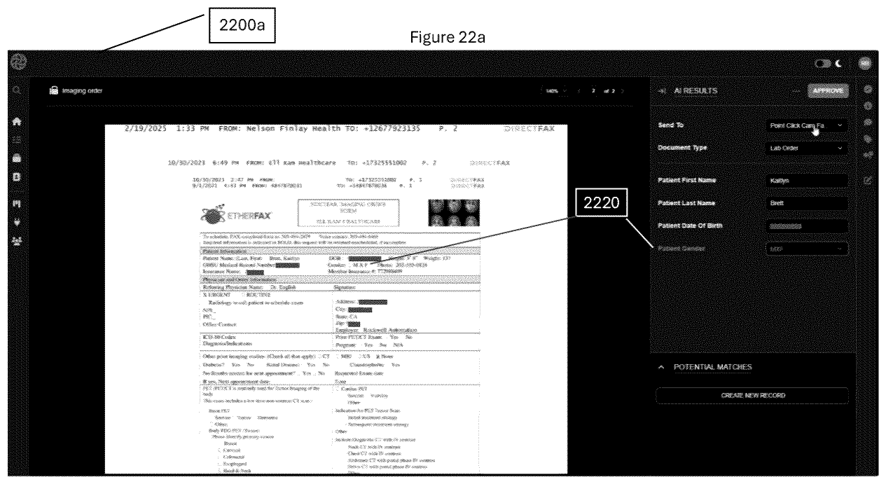

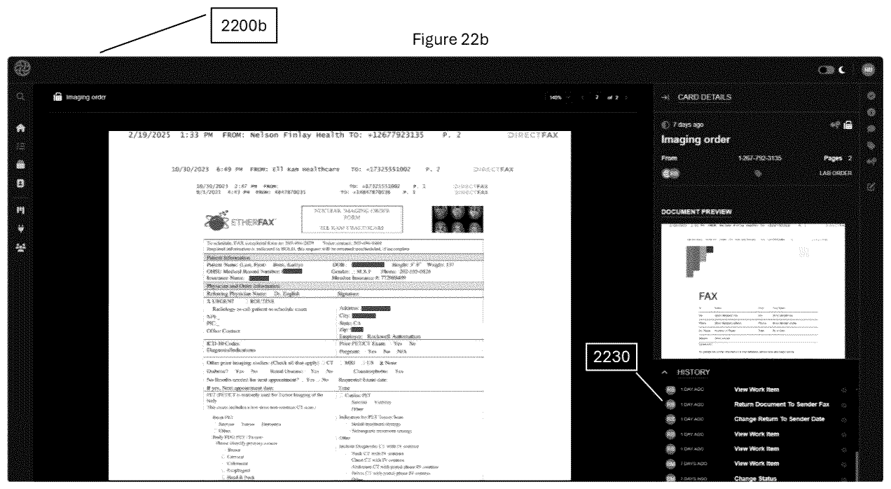

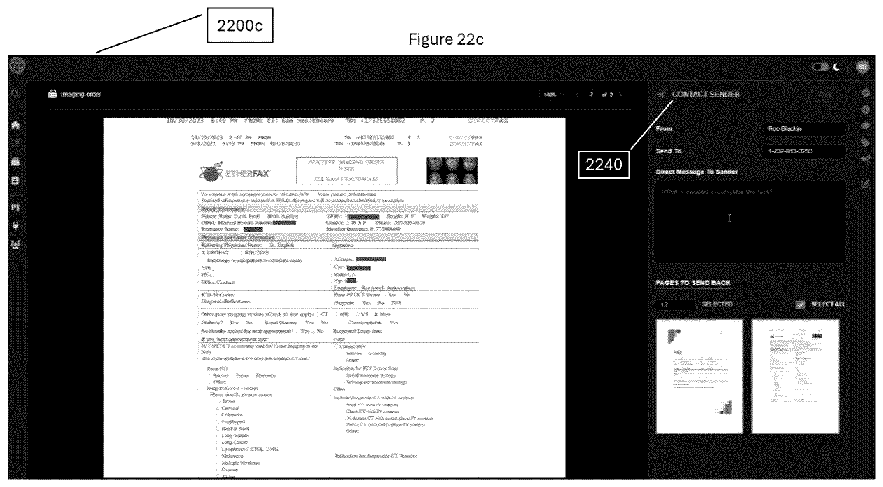

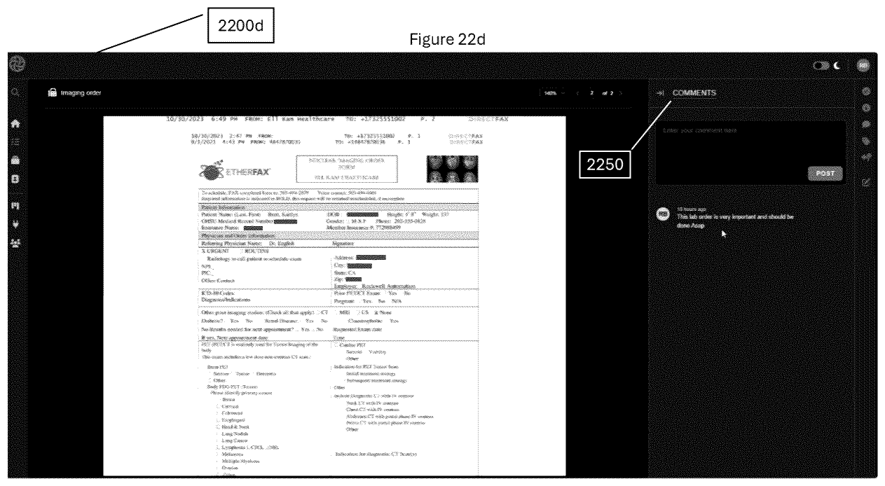

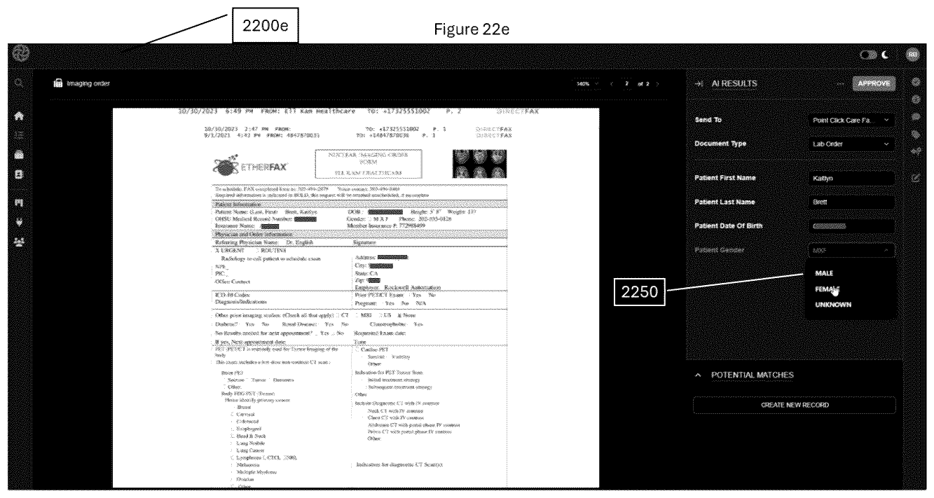

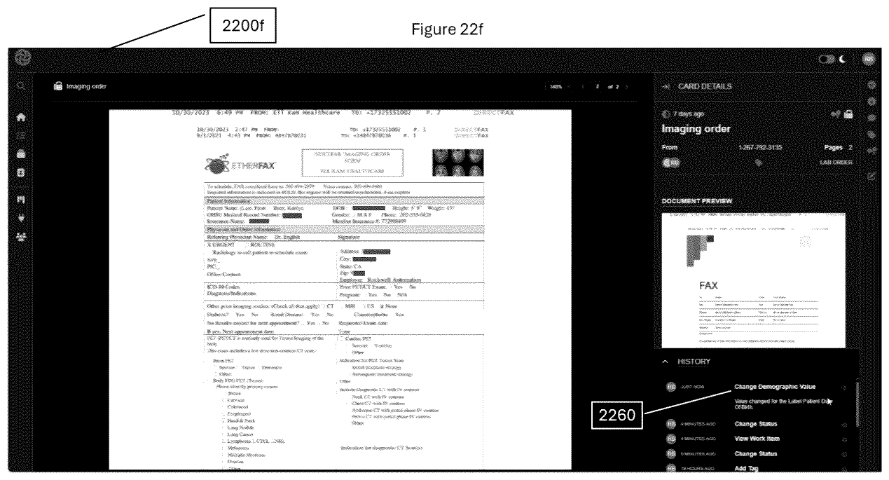

Similarly, referring to FIG. 22, in the non-limiting illustrative UI representation (2200) an operator has selected the option to triage the at least one received content, the extracted information, and/or contextual metadata. In this figure item (2210) is presenting the original second page of the received content of the selected task for perusal by the operator.

Referring to FIG. 22a, in the non-limiting illustrative UI representation (2200a) an operator has selected the option to triage the at least one received content, the extracted information, and/or contextual metadata. In this figure item (2220) is presenting that the Weave Flow technology was not able to correctly ascertain the patient's gender in a format as required by the upstream or downstream process. Referencing item (2220) you can see in the original content that the gender on this form is represented as a check box with the options of the characters M, X, and F. The Weave Flow technology noted this exception as the extracted information is in the format of MXF which is not what is expected by the upstream or downstream process, thus it is highlighted to alert the operator that this particular information needs to be reviewed. Those schooled in the art can see that the remainder of the information such as the Document Type, Patients First Name, Patients Last Name, and Patients Date of Birth was correctly extracted from the received content.

Referring to FIG. 22b, in the non-limiting illustrative UI representation (2200b), an operator has noticed that the Patient's Gender field is not correctly specified in the received content, thus is unable to allow the document to be forwarded to the upstream or downstream process as this is required information based upon an a priori arrangement. As such, the operator can select as shown by item (2230) to return the received content to the originator to correct the missing information. This action is noted in the history of the task as shown by item (2230).

Referring to FIG. 22c, in the non-limiting illustrative UI representation (2200c), an operator has the option of communicating additional information to the originator to further facilitate the required correction necessary to allow further processing of the received content. Item (2240) illustrates the ability of the operator to contact the sender of the information and provide any additional guidance.

Referring to FIG. 22d, in the non-limiting illustrative UI representation (2200d), an operator has the option associating comments with a selected task. Item (2250) represents the ability for the operator to include free-formed information that is relevant to the processing of the at least one received content, the extracted information, and/or contextual metadata.

Referring to FIG. 22e, in the non-limiting illustrative UI representation (2200e), an operator has the option of providing or overriding the presented at least one received content, the extracted information, and/or contextual metadata. In this non-limiting illustrative example, the item (2250) drop-down list shows acceptable values that the upstream or downstream process will accept. For instance, an operator may have a priori knowledge of the particular patient's gender, or they may have received information out of band, such as by a phone call with the originator of the communique, or an ex-parte communications with a medical provider. The provided out-of-band information may allow an operator to efficiently resolve any pending issues, instead of having to wait for the sender of the received content to correct and resubmit the content for reprocessing. Therefore, the non-limiting illustrative UI representation (2200e) allows an operator to select the appropriate information and potentially clear the task for additional processing.

Referring to FIG. 22f, in the non-limiting illustrative UI representation (2200f), shows that operations that affect the at least one received content, the extracted information, and/or contextual metadata are track in the history associated with the task. Item (2260) show that an operator modified the Patient's demographic information (i.e. the gender field) to be an acceptable value for an upstream or downstream process.

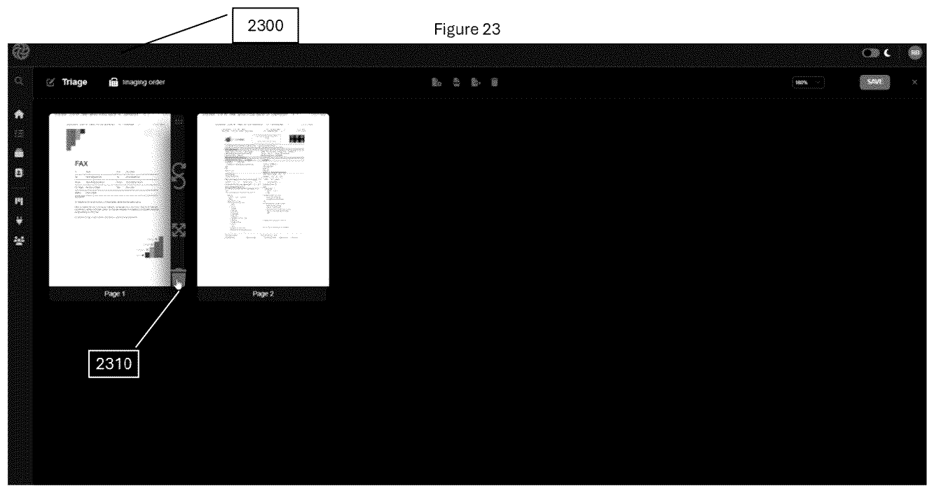

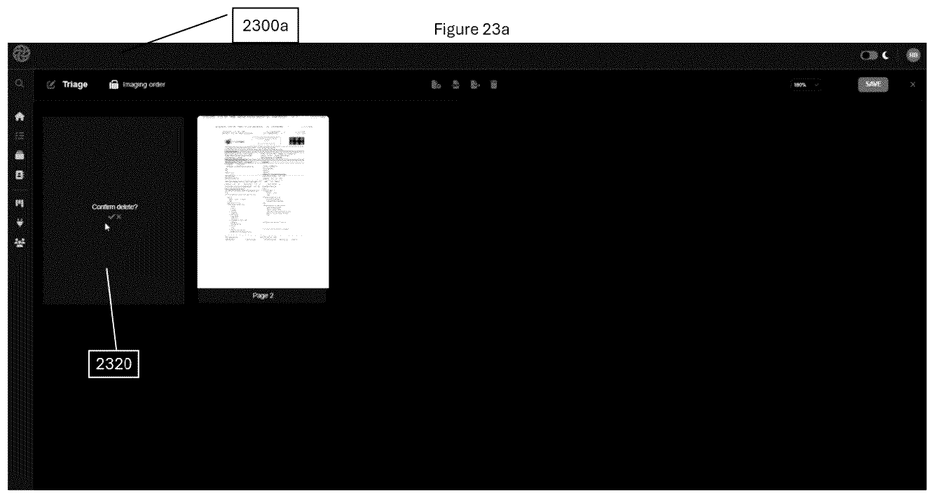

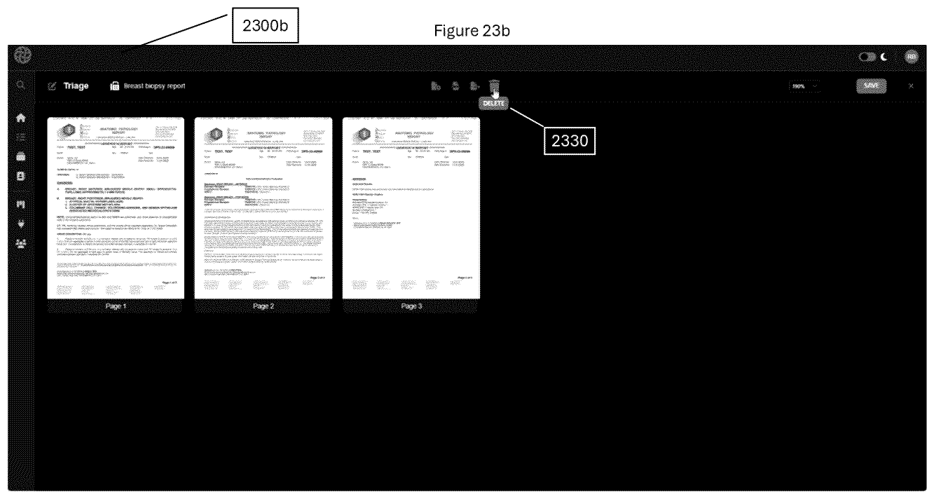

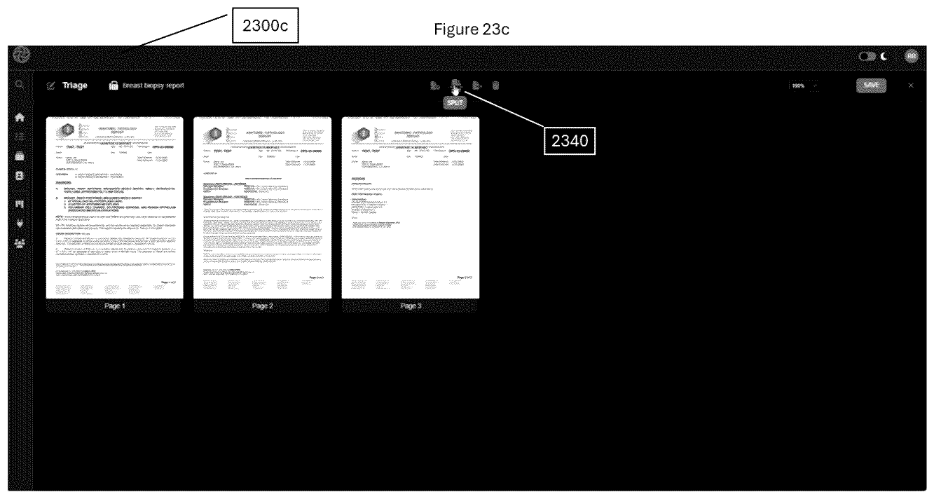

Referring to FIG. 23, in the non-limiting illustrative UI representation (2300), shown are the received content of a particular communique. It is quite possible that extraneous information is also received along with, or as part of any received content. For instance, the communique may contain a cover page that has no relevance to the actual information needing to be processed. Therefore, extraneous information may need to be purge from the content allowing for successful processing of the communique. Item (2310) is a non-limiting illustration of the ability of operator during triage to delete a particular page, as a page may have little to no relevance to the actual information that is being processed any subsequently submitted for ingestion by an upstream or downstream process.

Referring to FIG. 23a, in the non-limiting illustrative UI representation (2300a), the figure shows an additional confirmation step necessary by the non-limiting exemplary embodiment. Item (2320) indicates that an operator needs to further confirm that the requested delete of the page shown in FIG. 23 is to be expunged from the received content.

Referring to FIG. 23b, in the non-limiting illustrative UI representation (2300b), the figure shows an alternative way of deleting multiple pages at a time, an operator can highlight one or more pages to be deleted and then select the bulk delete option represented by item (2330). This operation allows for more efficient handling of multi-page documents.

Referring to FIG. 23c, in the non-limiting illustrative UI representation (2300c), the figure shows conversely to receiving extraneous information, it is possible to receive in one communique content that references multiple individuals, orders, transactions, etc. Therefore, it may require manual intervention to split the content into separate tasks to facilitate the successful processing and preparation for an upstream or downstream process to accept. The exemplary non-limiting UI embodiment (2300c) shows item (2340) as a way for an operator to split highlighted pages into separate tasks and resubmit those tasks for processing.

It is to be understood by those schooled in the art that it is possible to for the received content to be segmented in multiple communiques instead of one, therefore instead of a process requiring the information to be split into separate tasks, it is possible that multiple communiques need to be combined or merged together for proper processing of the information.

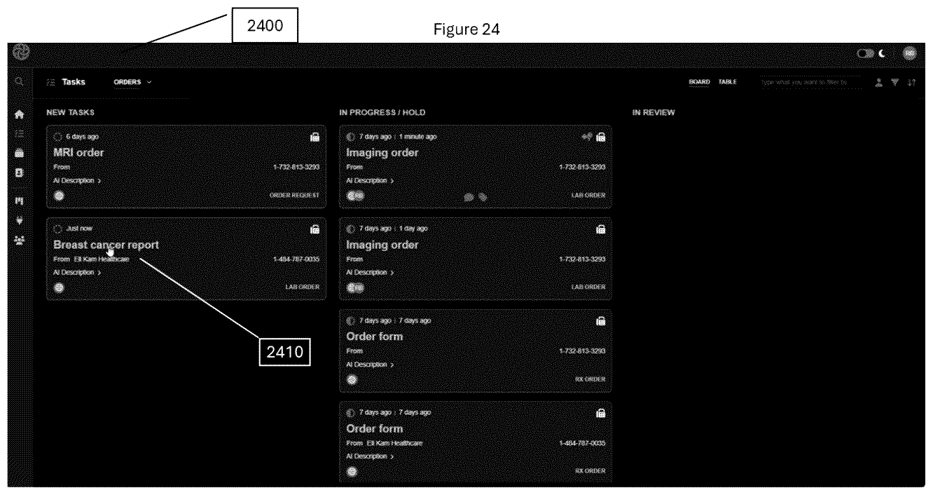

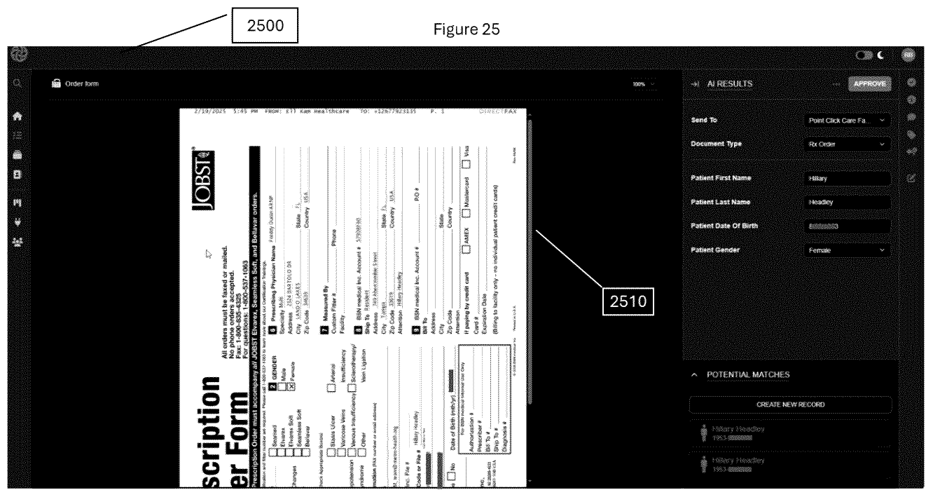

Referring to FIG. 24, the non-limiting illustrative UI representation (2400), shows in kanban format that the split/submitted task referenced in FIG. 23c, was processed by the Weave Flow technology. Item (2410) shows that the task was processed “Just now”, and indicating the efficiency of the system, instead of having an operator to contact the originator of the communique to resubmit the content as separate individual communiques that the upstream or downstream process is expecting.

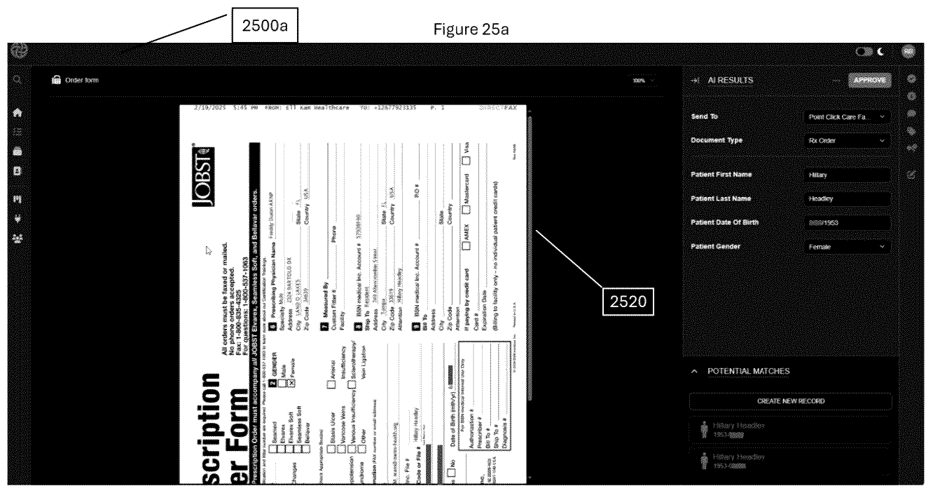

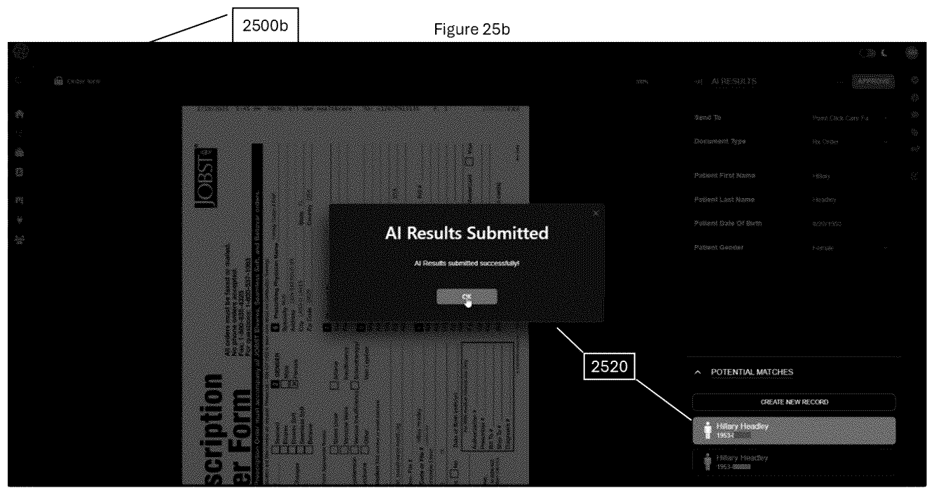

Referring to FIG. 25, the non-limiting illustrative UI representation (2500) shows the flexibility of the Weave Flow technology. Here the content of the communique was received rotate. Item (2510) was rotated 90 degrees from its proper orientation. Even with the information rotated, as shown in the non-limiting illustrative embodiment, the Weave Flow solution was able to correctly extract the information (e.g., Patient First Name, Patient Last Name, Patient Date of Birth, Patient Gender, etc.)

Referring to FIG. 25a, the non-limiting illustrative UI representation (2500a) shows that while the information was extracted correctly from the received content, the Weave Flow technology detected that its confidence in the extraction may be lower than a given threshold, thus requiring further validation. Via the review of item (2520) and verifying that the extracted information is correct, an operator can approve this submission quickly for transfer to the upstream or downstream process.

Referring to FIG. 25b, the non-limiting illustrative UI representation (2500b) shows that as part of the approval process, the operator may need to discern the correct upstream or downstream record the information is associated with. For instance, Item (2520) shows that there may be two patients with the same name. The Weave Flow technology may need to verify with the upstream or downstream process which record to associate the new information. The Weave Technology can further be integrated with the upstream or downstream process to validate whether or not there are existing records associated with the at least one received content, extracted data, or contextual metadata. If there is, the operator may be presented with a list of potential matches based on any extracted information. If no matches are apparent, the operator may have the ability to create a new record as indicated by item (2520). The operator can then approve the task and submit it to the upstream or downstream process. Upon completion, the non-limiting illustrative UI representation (2500b) shows that the submission operation was successfully completed.

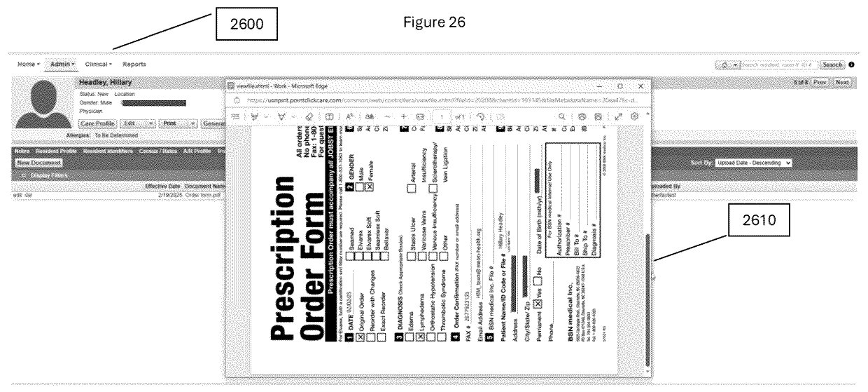

Referring to FIG. 26, the non-limiting illustrative UI representation (2600) shows that the at least one received content, extracted data, or contextual metadata has been successfully received and processed by an upstream or downstream process. In this non-limiting illustrative embodiment, the content reference in FIG. 25 has been communicated to the electronic medical record application and associated with the specified patient. Thus, the processes described herein are highly desirable and broadly applicable in the advancement of intelligent document processing (IDP) solutions.

Given that the Weave Flow technology may handle sensitive or classified information, the underpinnings of the system designed with security and privacy in mind. Access control lists (ACLs) based on role-based access control (RBAC) logic can be configured to manage access to that at least one received content, extracted data, or contextual metadata as well as other features and functionality of the system. An administrator of the system can assign permissions to an individual operator or group of operators, to limit access to certain types of (sensitive) information within the system or limit the execution of certain operations/functions of the system. Additional controls can further be in place to invoke an approval process before a task is routed to another step within the Weave Flow system.

Additionally, to ensure Weave Flow clients that their information will be handled with the utmost care regarding the security and privacy of there information, the Weave Flow technology includes provisions to secure the communications of information that traverses network interconnects utilizing industry standard encryption methodologies. For instance, industry standard transport layer security (TLS) encapsulation can be used to secure the exchange of information over network paths. In the event that information is stored at rest while being processed, storage and/or file base encryptions schemes can be employed. Additionally, the Weave Flow technology can utilize unique containers on a client-by-client or organization-by organization basis, providing physical separation of information when necessary. This methodology also allows each client or organization to optionally manage their own encryption keys for data that may be at rest.

It will be readily understood by those persons skilled that the Artificial Intelligence processes employed by the Weave Flow processes are not limited to just natural language processing, but include other methodologies, including but not limited to large language models (LLMs), generative AI services, etc.

It will be readily understood by those persons skilled in the art that the technology herein is susceptible to broad utility and application. Many embodiments and adaptations other than those herein described, as well as many variations, modifications and equivalent arrangements, will be apparent from or reasonably suggested by the foregoing description thereof, without departing from the substance or scope.

While the foregoing illustrates and describes exemplary embodiments of this non-limiting embodiment, it is to be understood that the non-limiting embodiment is not limited to the construction disclosed herein. The technology herein can be embodied in other specific forms without departing from its spirit or essential attributes.

We claim:

1. A method comprising:
receiving an unstructured data set;
transforming the unstructured data set into a data arrangement configured to be consumed by an upstream or downstream computational process, the transforming including extracting data from the unstructured data set;
testing the data arrangement to determine whether confidence in the data arrangement is below a threshold;
conditionally presenting the data arrangement for exception processing based on whether the testing reveals confidence in the data arrangement is below the threshold, the exception processing performing further analysis on the unstructured data set and/or the data arrangement; and
using a machine learning component executing on at least one processor to automatically generate a summary of the data arrangement.

2. The method of claim 1 wherein the data arrangement and the summary is presented on a user interface.

3. The method of claim 1 wherein the exception processing comprises human interaction for a predefined metric, a requirement, and/or learned rules.

4. The method of claim 1 wherein the exception processing includes analyzing handwritten information.

5. The method of claim 1 wherein the exception processing includes translating from one natural language to another natural language.

6. The method of claim 1 wherein the testing tests for missing data, grammatical errors, typographical errors, and classification errors.

7. The method of claim 1 wherein the testing tests whether the received unstructured data set is invalid altogether.

8. The method of claim 1 further including improving reliability of the data arrangement by minimizing potential for human error during a tedious, repetitive, and mundane transcription process.

9. The method of claim 1 wherein receiving comprises receiving information in many formats from many different inputs, and transforming comprises extracting and transforming the data set into content that can be consumed by another system or process.

10. A system comprising:
at least one processor configured to perform operations comprising:
receiving an unstructured data set;
transforming the unstructured data set into a data arrangement configured to be consumed by an upstream or downstream computational process, the transforming including extracting data from the unstructured data set;
testing the data arrangement to determine whether confidence in the data arrangement is below a threshold;
conditionally presenting the data arrangement for exception processing based on whether the testing reveals confidence in the data arrangement is below the threshold, the exception processing performing further analysis on the unstructured data set and/or the data arrangement; and
using a machine learning component executing on at least one processor to automatically generate a summary of the data arrangement.

11. The system of claim 10 wherein the data arrangement and the summary is presented on a user interface.

12. The system of claim 10 wherein the exception processing comprises human interaction for a predefined metric, a requirement, and/or learned rules.

13. The system of claim 10 wherein the exception processing includes analyzing handwritten information.

14. The system of claim 10 wherein the exception processing includes translating from one natural language to another natural language.

15. The system of claim 10 wherein the testing tests for missing data, grammatical errors, typographical errors, and classification errors.

16. The system of claim 10 wherein the testing tests whether the received unstructured data set is invalid altogether.

17. The system of claim 10 wherein the operations further include improving reliability of the data arrangement by minimizing potential for human error during a tedious, repetitive, and mundane transcription process.

18. The system of claim 10 wherein receiving comprises receiving information in many formats from many different inputs, and transforming comprises extracting and transforming the data set into content that can be consumed by another system or process.
